(19) United States
(12) Patent Application Publication
(10) Pub. No.: US 2002/0178875 A1
(43) Pub. Date: Dec. 5, 2002

(54) Combination wrench hammer set

(76) Inventor: Yuan-Ho Lin, Ta-Li City (TW)

Correspondence Address: CHARLES E. BAXLEY, ESQUIRE, Hart, Baxley, Daniels & Holton, 59 John St, 5 Fl,, New York, NY, 10038, US

(21) Appl. No.: 09/870,616

(22) Filed: Jun. 1, 2001

(51) Int. Cl. B25F 1/00

(52) U.S. Cl. 81/437

(57) ABSTRACT

A combination wrench hammer set includes a handle rod having two upright sidewalls, a combination tool head pivoted to one end of the handle rod, the combination tool head having a hollow angular socket at one end and a hammer head-shaped adjusting screw threaded into the hollow angular socket, and a handgrip structure mounted in one end of the handle rod remote from the combination tool head, the handgrip structure including a handle cover pivoted to a middle part of the handle rod and adapted to keep tools and tool bits, and an end block fixedly fastened to the handle rod, the end block having at least one polygonal tool coupling hole for holding the selected tool bit for working.

### BACKGROUND OF THE INVENTION

The present invention relates to a wrench hammer set and, more specifically, to a combination wrench hammer set with the combination of an adjustable wrench, a hammer, sleeve sockets, screwdrivers, pliers, etc., to enable multiple functions in a wrench hammer set.

Using various different hand tools has become a regular job in assembling and disassembling processes, a number of hand tools with a same function but with different specifications are required for various sizes. Therefore, the portability of hand tools has always been an objective for improvement by researchers, the most simple solution is to be able to incorporate all necessary hand tools in a tool box, but the capacity of a tool box is limited, if many hand tools are designed as individual piece with single functions, the variety of hand tools that can be put in a tool box will be quite limited, and in case each hand tool involves a handle, it will occupy a much larger space, but if the solution is aimed at increasing the cubic measurements and space of a tool box, it will not only fail to really solve the problem, but will also increase the burden of carrying it. Therefore, current solutions are aimed at the design of wrench hammer sets, with the hope to include more sets of tools with different functions on a same hand tool in order to save the space, so that with the cubic measurements of a conventional single piece of single-function hand too, various tool functions may be achieved, so that it will be convenient and fast to carry, operate, use or accommodate the tools. A similar design is seen in U.S. Pat. No. 5,970,553, entitled “WRENCH HAMMER SET”, issued to the present inventor. This structure of wrench hammer set comprises a handle rod, a combination tool head pivoted to the front half of the handle rod, and a handle cover covering the rear half of the handle rod. This structure of wrench hammer set has less storage space for holding tool members. Further, the wrench hammer set has no positioning means to secure the handle cover positively in the close position.

### SUMMARY OF THE INVENTION

The present invention has been accomplished to provide a combination wrench hammer set, which eliminates the aforesaid drawbacks. It is one object of the present invention to provide a combination wrench hammer set, which is provided with the combination of an adjustable wrench, a hammer, sleeve sockets, screwdrivers, pliers, etc., to enable multiple functions in the combination wrench hammer set. It is another object of the present invention to provide a combination wrench hammer set, which provides a magnetic handle cover that can be conveniently set between the open position for arrangement of storage tools and tool bits, and the close position to serve as a part of the handgrip. To achieve these and other objects of the present invention, the combination wrench hammer set comprises a handle rod having two upright sidewalls, a combination tool head pivoted to one end of the handle rod, the combination tool head having a hollow angular socket at one end and a hammer head-shaped adjusting screw threaded into the hollow angular socket, and a handgrip structure mounted in one end of the handle rod remote from the combination tool head, the handgrip structure including a handle cover pivoted to a middle part of the handle rod and adapted to keep tools and tool bits, and an end block fixedly fastened to the handle rod, the end block having at least one polygonal tool coupling hole for holding the selected tool bit for working.

### BRIEF DESCRIPTION OF THE DRAWINGS

FIG. 1 is an elevational view of a combination wrench hammer set constructed according to the present invention.

FIG. 2 is a perspective exploded view of the combination wrench hammer set according to the present invention.

FIG. 3 shows an application example of the combination wrench hammer set according to the present invention.

FIG. 4 illustrates the structure of the folding combination hand tool for the combination wrench hammer set according to the present invention.

FIG. 5 illustrates an alternate form of the handle cover for the combination wrench hammer set according to the present invention.

### DETAILED DESCRIPTION OF THE PREFERRED EMBODIMENT

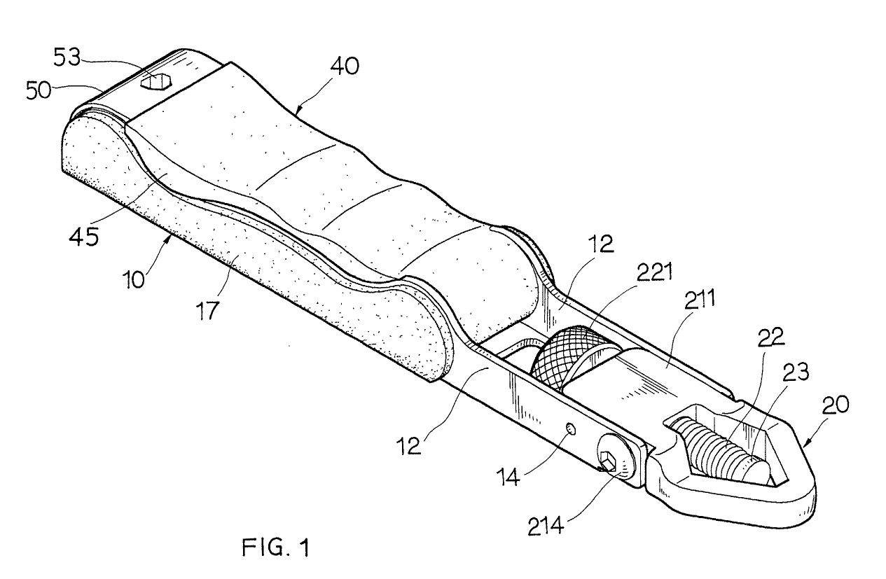

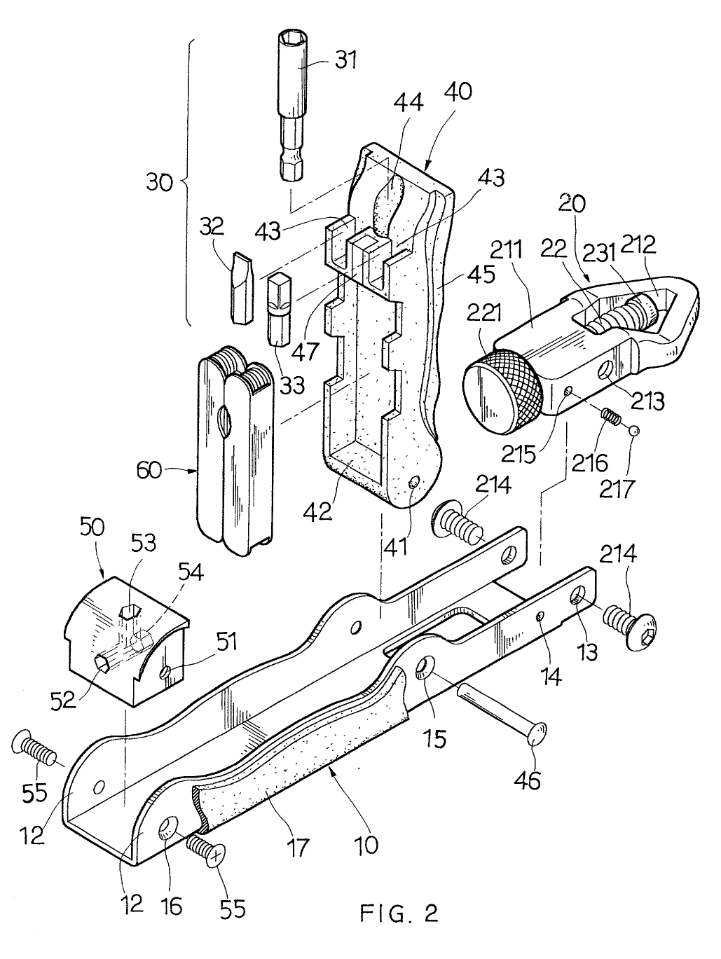

Referring to FIGS. 1 and 2, the invention of combination wrench hammer set comprises a handle rod 10, a combination tool head 20, a handgrip structure formed of a handle cover 40 and an end block 50 and mounted in one end, namely, the rear end of the handle rod 10, a combination tool bit set 30, and a folding combination hand tool 60.

The handle rod 10 is shaped like a channel bar comprising two upright sidewalls 12, and a rubber covering 17 adhered to the outer surface of the rear end thereof for comfortable gripping of the hand.

The combination tool head 20 comprises a joining part 211 at one end, a hollow angular socket 212 at the other end, and an adjusting screw 22 axially threaded through the joining part 211. The adjusting screw 22 has a hammer block 221 with an expanded diameter at its one end and a pushing block 231 at its other end. The joining part 211 comprises a screw hole 213 on each of the two opposite lateral sides thereof respectively pivoted to a respective through hole 13 on one end, namely, the front end of each of the upright sidewalls 12 of the handle rod 10 by a respective screw 214, a recessed hole 215 near one end on one lateral side, a spring 216 positioned in the recessed hole 215, and a round ball 217 supported on the spring 216. The round ball 217 is forced into engagement with a recessed hole 14 on one upright sidewall 12 of the handle rod 10 to hold the combination tool head 20 in position when the combination tool head 20 and the handle rod 10 are extended horizontally. During operation, the user can rotate the hammer block 221 to move the adjusting screw 22 forwards/backwards, so that the pushing block 231 will coordinate with the socket 212, to form different spaces to accommodate different work pieces and serve as an adjustable wrench. The user can also turn the combination tool head 20 to a vertical position perpendicular to the handle rod 10 for hammering a workpiece with the hammer block 221.

The handle cover 40 is a hollow member injection-molded from plastics, comprising a pivot hole 41 transversely extended through one end thereof and pivotally connected to a respective pivot hole 15 on each of the two upright sidewalls 12 of the handle rod 1 by a pivot 46, two side flanges 45 through which the handle cover 40 can be moved in and out of the handle rod 10 with the hand, a magnet 47 fixedly mounted in an inside recessed hole thereof and adapted to secure the handle cover 40 to the handle rod 10 in the close position by magnetic attraction, a combination handle tool storage chamber 42 adapted to receive the folding combination hand tool 60, and multiple tool bit storage chambers 43 adapted to receive the combination tool bit set 30.

The end block 50 is a sector-like metal block configured to fit the rear end of the handle rod 10 and the rear end of the handle cover 40 for comfortable gripping of the hand, comprising a screw hole 51 disposed on each of the two opposite lateral sidewalls thereof and respectively connected to a respective tapered through hole 16 on each of the upright sidewalls 12 of the handle rod 10 by a respective screw 55, a horizontally extended polygonal tool bit coupling hole 52, a vertically extended polygonal tool bit coupling hole 53, and a magnet 54 fixedly mounted in one end of the horizontally extended polygonal tool bit coupling hole 52.

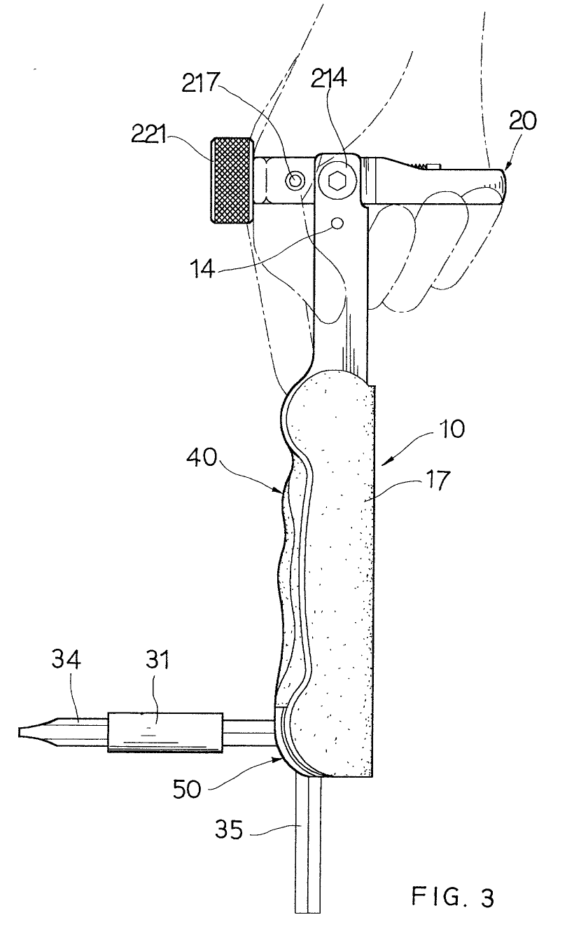

The combination tool bit set 30 comprises at least one socket rod 31, one cabinet tip tool bit 32, and one rectangular head adapter rod 33. The socket rod 31 is received in an elongated slot 44 in the handle cover 40. The other members of the combination tool bit set 30 are respectively received in the tool bit storage chambers 43 of the handle cover 40. When performing a loosening or tightening operation (see FIG. 3), the can select the horizontally extended polygonal tool bit coupling hole 52 or the vertically extended polygonal tool bit coupling hole 53 to apply force. For a long loosening stroke, the user can pick up the socket rod 31 from the handle cover 40 and then fasten the socket rod 31 to the horizontally extended polygonal tool bit coupling hole 52, and then attached to the desired tool bit to the socket rod 31 for operation, and then the combination tool head 20 and the tool rod 10 are set at right angles so that the user can hold the combination tool head 20 with the hand to turn the handle rod 10 and the workpiece efficiently. Further, after insertion of the socket rod 31 into the horizontally extended polygonal tool bit coupling hole 52, the magnet 54 attracts the socket rod 31, keeping the socket rod 31 in position.

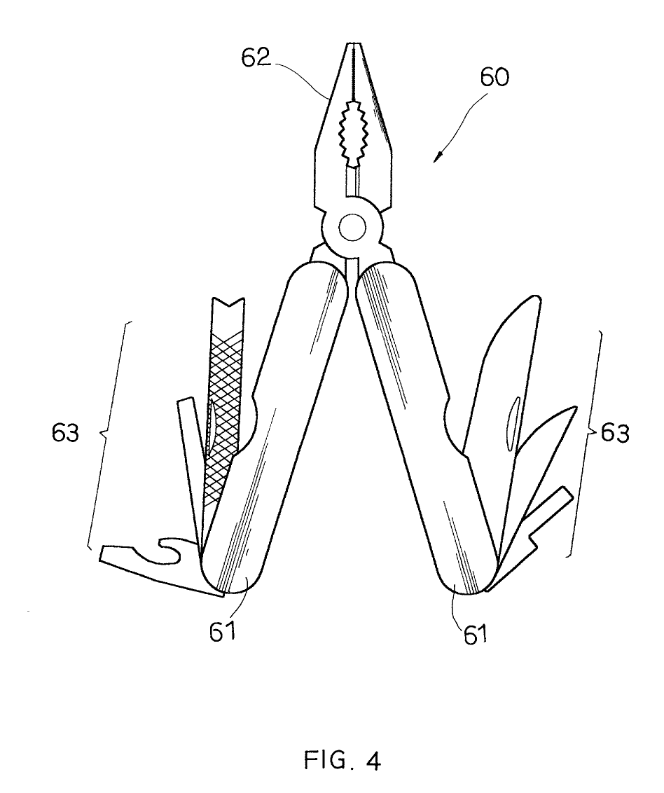

The folding combination hand tool 60, please refer to FIGS. 2 and 4, comprises a lineman's pliers 62, two hollow handles 61 shaped like a channel bar and respectively pivoted to the lineman's pliers 62, and multiple tool elements 63 respectively pivoted to the hollow handles 61. The hollow handles 61 can be turned relative to the lineman's pliers 62 between the open position where the hollow handles 61 are extended out of the lineman's pliers 62 and operated to open/close the lineman's pliers 62 (see FIG. 4), and the close position where the hollow handles 61 are abutted against each other side by side and the lineman's pliers 62 is received in between the hollow handles 61 and kept from sight (see FIG. 2).

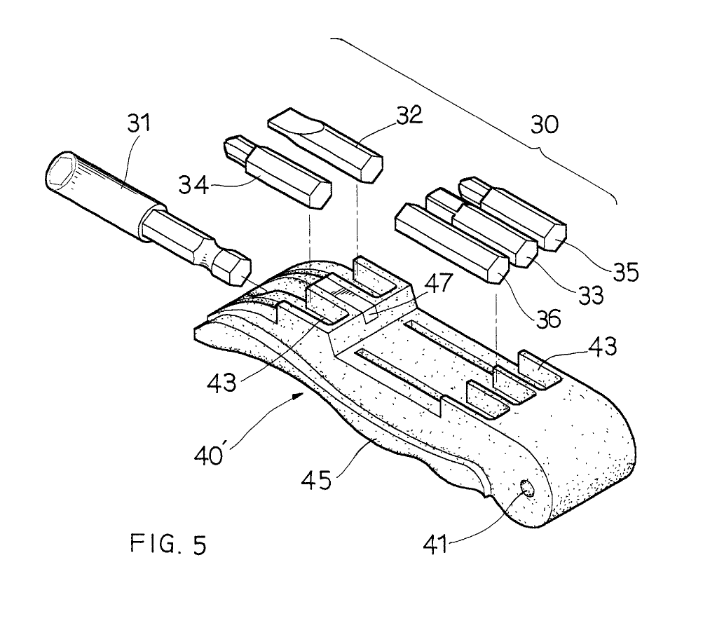

FIG. 5 shows an alternate form of the handle cover according to the present invention. According to this alternate form, the handle cover 40′ comprises an elongated slot 44 and five tool bit storage chambers 43 adapted to receive one socket rod 31, one cabinet tip tool bit 32, one rectangular head adapter rod 33, two Phillips head tip tool bits 34 and 35, and one polygonal adapter rod 36.

A prototype of combination wrench hammer set has been constructed with the features of FIGS. 1-5. The combination wrench hammer set functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A combination wrench hammer set comprising:
a handle rod, said handle rod comprising a front end, a rear end, and two upright sidewalls;
a combination tool head pivoted to the front end of said handle rod, said combination tool head comprising a hollow angular socket at one end, and a hammer head-shaped adjusting screw threaded into said hollow angular socket; and
a handgrip structure mounted in the rear end of said handle rod, said handgrip structure comprising a handle cover pivoted to a middle part of said handle rod, and an end block fixedly fastened to the rear end of said handle rod.

2. The combination wrench hammer set of claim 1 wherein said handle rod further comprises a rubber covering covered on an outer surface of the rear end thereof.

3. The combination wrench hammer set of claim 1 wherein said handle cover is injection-molded from plastics.

4. The combination wrench hammer set of claim 1 wherein said handle cover comprises a magnet mounted in an inside recessed hole thereof and adapted to secure said handle cover to said handle rod in a close position by magnetic attraction.

5. The combination wrench hammer set of claim 1 wherein said handle cover comprises two side flanges at two opposite lateral sides.

6. The combination wrench hammer set of claim 1 wherein said handle cover comprises at least one folding combination hand tool, and at least one combination hand tool chamber adapted to receive said at least one folding combination hand tool.

7. The combination wrench hammer set of claim 6 wherein said at least one folding combination hand tool includes a folding combination lineman's pliers.

8. The combination wrench hammer set of claim 1 wherein said handle cover comprises at least three tool bit storage chambers.

9. The combination wrench hammer set of claim 8 further comprising at least one socket rod, one cabinet tip tool bit, and one rectangular head adapter rod respectively received in said at least three tool bit storage chambers.

10. The combination wrench hammer set of claim 8 wherein said at least three tool bit storage chambers include an elongated tool bit storage chamber adapted to receive an elongated socket rod.

11. The combination wrench hammer set of claim 8 wherein said at least one socket rod each has one end terminating in a polygonal rod and an opposite end terminating in a polygonal socket.

12. The combination wrench hammer set of claim 1 wherein said end block is a metal sector block.

13. The combination wrench hammer set of claim 1 wherein said end block comprises at least one polygonal tool bit coupling hole.

14. The combination wrench hammer set of claim 1 wherein 13 wherein said at least one polygonal tool bit coupling hole each has an inner end fixedly mounted with a magnet.
